(19) United States
(12) Patent Application Publication
(10) Pub. No.: US 2010/0306539 A1
(43) Pub. Date: Dec. 2, 2010

(54) METHOD AND SYSTEM FOR CONTENT DELIVERY CONTROL USING A PARALLEL NETWORK

(75) Inventors: L. Lloyd WILLIAMS, Kanata (CA); Alexander MARKMAN, Thornhill (CA); David Edward JOHNSTON, Whitby (CA); William B. CRAGO, Stouffville (CA)

Correspondence Address: SMART & BIGGAR, 1000 DE LA GAUCHETIERE ST. W., SUITE 3300, MONTREAL, QC, H3B 4W5, CA

(73) Assignee: BELL CANADA, Montreal (CA)

(21) Appl. No.: 12/830,093

(22) Filed: Jul. 2, 2010

Related U.S. Application Data
(63) Continuation of application No. 11/150,610, filed on Jun. 10, 2005.
Application No. 11/150,610 is a continuation of application No. 09/817,878, filed on Mar. 26, 2001, now abandoned.

(51) Int. Cl. G06F 15/16; H04L 9/32; G06F 17/30

(52) U.S. Cl. 713/168; 709/217; 707/769; 707/E17.014

(57) ABSTRACT

A method and system for controlling distribution of content through a communications network uses a second, parallel network for delivery of a transaction indicia to a requesting party. The use of the parallel network enables the transaction indicia to be forwarded to the party independently of the communications network, thereby reducing the probability of a party fraudulently obtaining delivery of the content. Additionally, information associated with the parallel network can be used to restrict distribution of the content to parties within a predetermined domain, such as, for example, a geographical region. The content may be delivered to the party in an encrypted form, preferably using an encryption algorithm and key designed to enable decryption of the content on only the content delivery device from which the request for the content was originated.

### CROSS-REFERENCE TO RELATED APPLICATIONS

This is the first application filed for the present invention.

### MICROFICHE APPENDIX

Not Applicable.

### TECHNICAL FIELD

The present invention relates to distribution of content through a communications network, and in particular to a method an apparatus for controlling the distribution of the content using a parallel network.

### BACKGROUND OF THE INVENTION

Recent advances in data communications technology have resulted in a dramatic increase in on-line services in which content of various types may be accessed and downloaded by interested parties. A virtually unlimited variety of content may be accessed and distributed through a communications network in this manner. Content distribution may be characterized as either unicast (that is, point-to-point between a content provider and a single party) or multicast (simultaneous distribution of content from a single content provider to multiple parties distributed across the communications network). In either case, access to the content is typically restricted to authorized parties, and/or granted in exchange for payment. In such cases, a convenient and effective means of authenticating a party requesting access to the content is required. Additionally, a simple and effective payment mechanism is required.

Modern communications networks such as the Internet are proving increasingly effective for both unicast and multicast distribution of content. However, experience has shown that it is a relatively easy matter for unauthorized persons to fraudulently gain access to content through such networks. This is due, at least in part, to the fact that addresses on the communications network are not uniquely associated with any particular location or individual. Thus it is very difficult, based on the content of messages received through the communications network, to positively verify the identity of the individual party who originated the message. Various schemes have been proposed for addressing the problem of verifying the identity of a party requesting access to content. Typically, these schemes involve the use of predetermined user IDs and passwords, and rely on the secrecy of the passwords to authenticate the identity of a party. However, the use of passwords has inherent limitations, because relatively simple passwords may be guessed or otherwise discovered, while more complicated passwords are also vulnerable to discovery and are likely to be forgotten by the user.

The difficulties associated with authenticating the identity of a party is compounded in cases where access to the content is permitted in exchange for payment. In these cases, it is necessary to verify not only the identity of the party, but also ensure authorized transfer of funds. The difficulties associated with ensuring that both of these functions are successfully completed, while at the same time preserving ease of use, have been identified as one of the impediments to the widespread deployment of services based on payment for content.

Another difficulty with the distribution of content through a communications network lies in the fact that a content provider may be required (e.g., by the laws and/or regulations of various jurisdictions) to restrict the distribution of content to certain predetermined domains. For example, a content provider may be required to prevent the distribution of content to parties located in a certain geographical region. In other instances, a content provider may be required to limit the distribution of content to within a specific network domain. In either case, such control over the distribution of content requires that the content provider have knowledge of a location of the party requesting access to the content. However, in the modern data communications space, address and identity information of users of the communications network are typically unrelated to geographical location, and thus there is no mechanism by which the content provider can independently verify a geographical location of a party requesting access to the content.

Accordingly, a method and system for controlling distribution of content through a communications network, with simple and efficient verification of party identity and location, remains highly desirable.

### SUMMARY OF THE INVENTION

An object of the present invention is to provide a method and system of controlling distribution of content through a communications network, that overcomes the above-noted limitations of the prior art.

Accordingly, an aspect of the present invention provides a method of controlling distribution of content through a communications network. A request message is received from a party through the communications network. The request message includes information identifying the party. A transaction indicia uniquely associated with the request message is formulated, and conveyed to the party through either one of the communications network and a parallel network that is substantially independent of the communications network. A validation message containing the transaction indicia is subsequently returned by the party through the other of the communications network and the parallel network.

The information identifying the party may include any one or more of: an address of the party on the parallel network; a User ID; and a user password.

In some embodiments, formulation of the transaction indicia includes authenticating a right of the party to receive the content. This may include determining whether the party is located within a predetermined domain. The predetermined domain may include any one or more of: a predetermined geographical region; a service area of a network service provider; an Internet domain; a customer; and, a company employee. The information identifying the party contained in the request message may be used to query a database including respective domain information of the party.

The transaction indicia may be conveyed to the party by establishing a connection to the party through the parallel network, using the information identifying the party. The transaction indicia can then be conveyed to the party through the connection. Establishment of the connection may include determining an address of the party on the parallel network. This may be accomplished by using information identifying the party to query a database including respective address information of the party.

In some embodiments, the parallel network is the Public Switched Telephone Network (PSTN). In such cases, the link to the party is a call connection set up between an Interactive Voice Response (IVR) server and a telephone handset of the party.

In some embodiments, information uniquely identifying a data communications device associated with the party is also received. An encryption key may be generated using the information uniquely identifying the data communications device, and the content encrypted using the encryption key. The encrypted content can then be forwarded to the data communications device associated with the party through the communications network. The information uniquely identifying the data communications device associated with the party may be a Media Access Control (MAC) address of the data communications device.

Using this arrangement, an encryption applet or script can be downloaded to the party's data communications device, in order to enable decryption of the encrypted content. In order to perform this function, the encryption applet or script probes the party's data communications device for the information (e.g. a MAC address) uniquely identifying the data communications device. This information is then used to decrypt the encrypted content. Since every data communications device has a unique MAC address that is not easily hidden (or spoofed), the encrypted content can only be decrypted by that data communications device.

Thus the present invention provides a method and system for controlling distribution of content through a communications network using a second, parallel network. The use of the parallel network enables a transaction indicia to be forwarded to the party through one of the networks and returned through the other, thereby reducing the probability of a party fraudulently obtaining access to the content. The probability of fraudulent use is further reduced by using the transaction indicia only once and for only one transaction. The probability of fraudulent use can be even further reduced by assigning the transaction indicia a limited time to live, and canceling the transaction if validation is not completed within the limited time to live. Additionally, information accessible through the parallel network can be used to restrict distribution of the content to parties within a predetermined domain, such as, for example, a geographical region. As well, the content may be distributed to the party in an encrypted form, preferably using an encryption algorithm and key designed to enable decryption of the content on only the data communications device from which the request for the content was originated.

### BRIEF DESCRIPTION OF THE DRAWINGS

Further features and advantages of the present invention will become apparent from the following detailed description, taken in combination with the appended drawings, in which:

FIG. 1. is a block diagram schematically illustrating exemplary elements in a system in accordance with the present invention:

FIGS. 2a and 2b are message flow diagrams schematically illustrating principle steps in a method of controlling distribution of content in accordance with a first embodiment of the present invention;

FIG. 3 is a message flow diagram schematically illustrating principle steps in a process of transferring encrypted content to a requesting party, in accordance with an embodiment of the present invention; and

FIGS. 4a and 4b show a message flow diagram schematically illustrating principle steps in a process of controlling distribution of content in accordance with a second embodiment of the present invention.

It will be noted that throughout the appended drawings, like features are identified by like reference numerals.

### DETAILED DESCRIPTION OF THE PREFERRED EMBODIMENT

The present invention provides a method and system for controlling distribution of content through a communications network, in which a second, parallel network is used for verification and authorization of a party requesting delivery of the content.

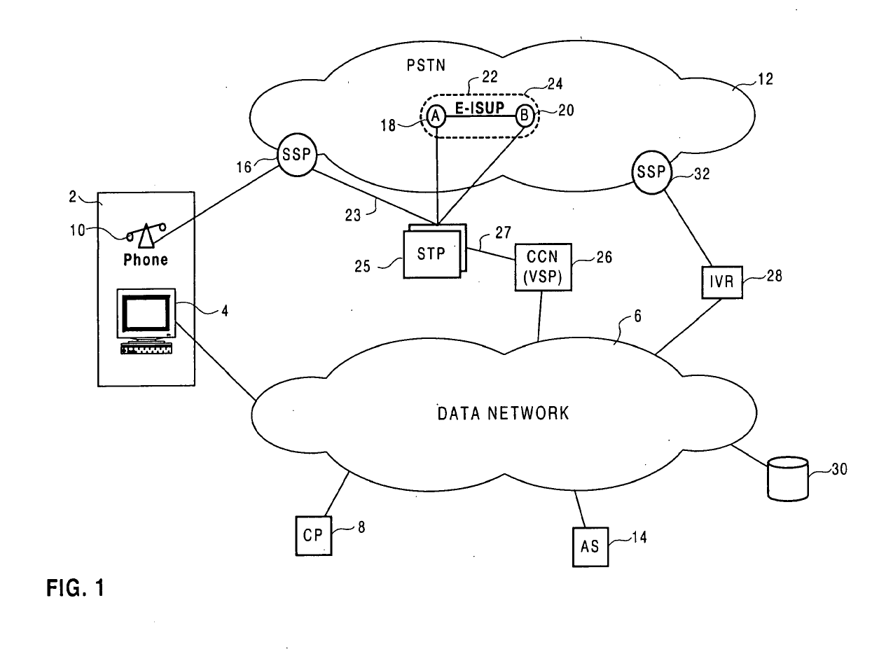

FIG. 1 is a block diagram schematically illustrating exemplary network elements that may be configured for content in accordance with an embodiment of the present invention. As shown in FIG. 1, a requesting party 2 uses a conventional data communications device 4 (e.g. a personal computer) coupled to a communications network 6 such as, for example, the Internet, to communicate with a content provider 8 to request delivery of the content. In addition, the requesting party 2 may use a conventional voice communications device 10 (e.g. a Plain Old Telephone Service [POTS] hand-set) coupled to the Public Switched Telephone Network (PSTN) 12 for voice communications. It will be appreciated that, in some instances the requesting party's data communications device 4 may access the communications network 6 via a dial up connection through the PSTN 12. However, for ease of illustration of the present invention, the requesting party's data communications device 4 is illustrated as if it were directly connected to the communications network 6, as this reflects the functional connectivity of the data communications device 4. For the purposes of the present invention, the connections between the requesting party's data communications device 4 and the data network 6, and between the requesting party's voice communications device 10 and the PSTN 12, are considered to be independent.

In accordance with the illustrated example, interaction between the requesting party 2 and the content provider 8 for the purposes of requesting access to the content (and subsequent distribution of the content to the requesting party 2) is handled through the communications network 6 using the requesting party's data communications device 4. It should be understood, however, that the content may be delivered through the PSTN 12 to the requesting party's voice terminal 10, which may be an Analogue Display Service Interface (ADSI) device, for example. In order to verify the identity and location of the requesting party 2, authentication and authorization functions are performed using a voice communications link through a parallel network, which in the present embodiment is the PSTN 12, or the data network 6. In general, content distribution and requesting party authentication functions may be performed within a single content provider server, or in separate servers, as desired. In the illustrated implementation, a content provider server 8 is used for request processing and content distribution, while a separate authentication server 14 provides requesting party authentication and authorization functions. The distribution of functionality is, however, a matter of design choice and any one or more of the functions may be performed by separate servers, or by separate entities.

As described above and shown in FIG. 1, the requesting party's telephone 10 is connected by a subscriber line to a Service Switching Point (SSP) 16 in the Public Switched Telephone Network (PSTN) 12, in a manner well known in the art. Typically, the SSP 16 serves a plurality of subscriber lines, and is coupled to a plurality of other SSPs (not shown) in the PSTN 12 by a plurality of trunks (not shown). In accordance with the present invention, the SSPs 18, 20 are provisioned with Enhanced Integrated Services Digital Network User Part (E-ISUP) trunks 22 to form an E-ISUP group 24. An E-ISUP trunk 22 is distinguished from regular trunks by the fact that a Call Control Node (CCN) 26 is provisioned as a logical switching node (virtual SSP or VSP) between terminating ends of the E-ISUP trunk 22, as explained in more detail in Applicants' copending U.S. patent application Ser. No. 08/939,909 entitled METHOD AND APPARATUS FOR DYNAMICALLY ROUTING CALLS IN AN INTELLIGENT NETWORK, which was filed on Sep. 29, 1997, and is incorporated herein by reference. Consequently, routesets and linksets at SSPs 18 and 20 which terminate opposite ends of the E-ISUP trunk 22 are provisioned to direct ISUP call control messages to the call control node 26 over signaling trunks 23 of a common channel signaling network. As is well known in the art, the common channel signaling network includes one or more Signal Transfer Point (STP) pairs 25. The call control node 26 is also coupled directly or indirectly to the communications network 6. The call control node 26 is enabled to dynamically set up calls between arbitrary end-points in the PSTN 12 in response to instructions sent through the communications network 6. In accordance with the present invention, this functionality is used to enable interaction between the authentication server 14 and the requesting party 2 using a call connection established between an Interactive Voice Response (IVR) server 28 and the requesting party's telephone 10.

In general, when a request for content delivery is received by the content provider 8, the authentication server 14 operates to verify the identity of the requesting party 2, as well as the right of the requesting party 2 to receive the requested content. This may involve determining a location of the requesting party 2. Upon successful authentication of the requesting party 2, a transaction indicia is generated and conveyed to the requesting party 2 via the call connection to the requesting party's telephone 10. The requesting party 2 then forwards the transaction indicia to the content provider 8 using their data communications device 4, in order to obtain delivery of the requested content. It is readily appreciated that this provides enhanced control over distribution of the content by enabling reliable verification of the requesting party's identity, and by providing a means of determining a physical location of the requesting party 2. In particular, while a requesting party 2 may conceal their identity in messages sent through the communications network 6, successful access to the content requires that they receive the transaction indicia through their telephone 10. Since the call connection used to forward the transaction indicia to the requesting party 2 is initiated within the network (that is, the requesting party 2 receives a telephone call via which the transaction indicia is provided to them) the requesting party 2 must provide a valid telephone number at which they can be reached. The telephone number can be used as an index for searching one or more databases 30 to identify the requesting party 2 (or at least the subscriber to whom the telephone number has been assigned), as well as a geographical location of the telephone 10.

It should be understood that the method in accordance with the present invention may be implemented in various ways to exploit the functional capabilities of legacy or emerging network systems. Thus, for example, authentication of the requesting party 2 may be performed by the content provider 8, or by a separate authentication server 14, or in fact by both the content provider 8 and authentication server 14 operating in concert. Any one or more of a variety of known authentication procedures may be used to verify the identity of the requesting party 2, and these known procedures may be used alone or in combination with determination of the requesting party's location in accordance with the present invention.

Upon successful completion of requesting party authentication, a transaction indicia is generated and communicated to the requesting party via a call connection to the requesting party's telephone 10. Various methods known in the art can be used to set up the call, and communicate the transaction indicia to the requesting party 2.

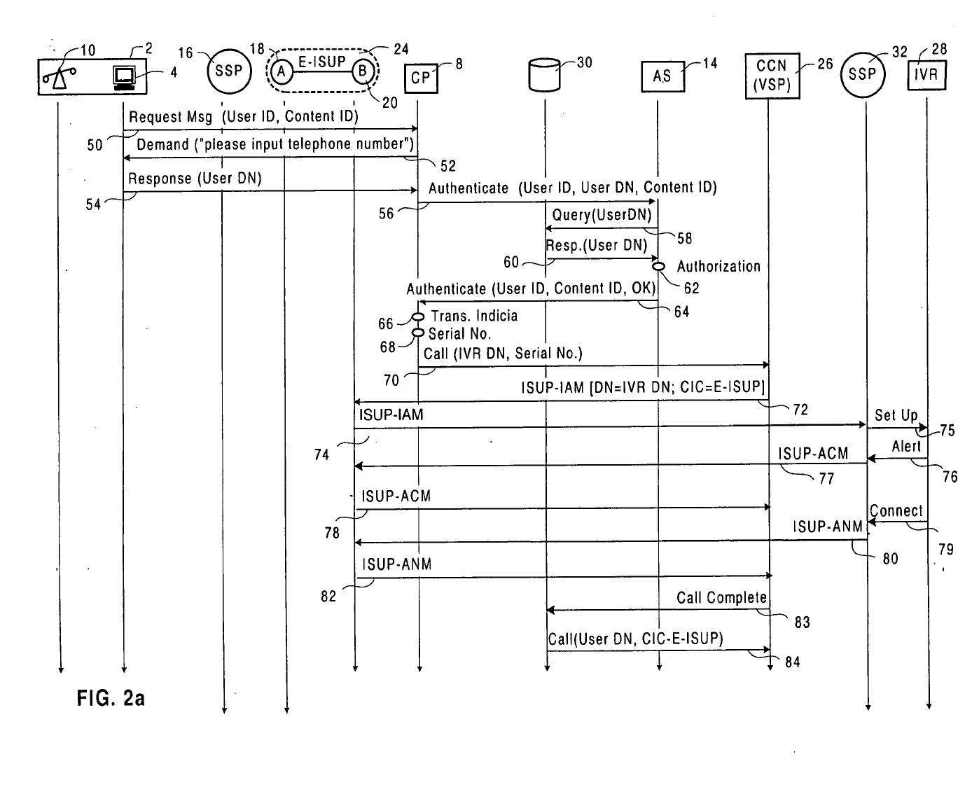

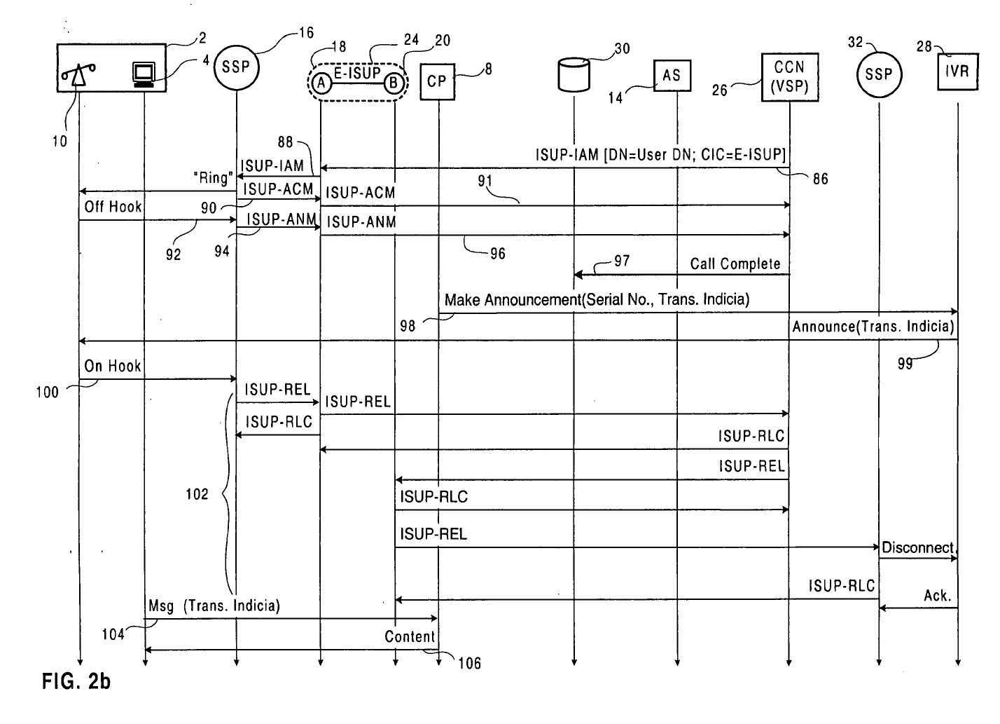

After receiving the transaction indicia, the requesting party must communicate the transaction indicia to the content provider 8 using, for example, an input window displayed on the requesting party's PC 4. It should be noted that a transaction indicia is preferably used only once, and is valid only for one transaction. In order to further ensure security, each transaction indicia may be assigned a limited time to live (five minutes, for example). If the time to live for a transaction indicia expires before the transaction indicia is returned to the content provider, the transaction is canceled. Upon receipt of a valid transaction indicia input by the requesting party 2, the content provider 8 delivers the requested content to the requesting party 2. Various mechanisms may be used to deliver the content, including, for example, conveying the content through the communications network 6 to the requesting party's data communications device 4, or alternatively, forwarding a URL or other address through the communications network 6 to the requesting party's data communications device 4 in order to thereby link the data communications device 4 to an address on the communications network 6 from which the content may be retrieved. In either case, the content transferred to the requesting party's data communications device 4 may be conveyed in an encrypted or unencrypted form. If encryption is used, various encryption algorithms may be used without departing from the scope or intent of the present invention. Exemplary uses of the methods and systems in accordance with the invention are described below with reference to FIGS. 2a through 4b.

FIGS. 2a and 2b are message flow diagrams illustrating principle messages exchanged between components of a system for content delivery in accordance with a first exemplary embodiment of the invention.

As shown in FIG. 2a, a content request message 50 containing information identifying the requesting party and the requested content is formulated using the requesting party's data communications device 4 and forwarded to the content provider 8. This request message may, for example, be automatically generated when the requesting party 2 “clicks” an icon on a web page displayed on the data communications device 4 that represents content that the requesting party 2 wishes to receive. In response to the request message, the content provider 8 returns a demand message 52 to the data communications device 4 prompting the requesting party to input the requesting party's telephone number. The demand message may also require the input of change information and/or other identification or authorization information. The telephone number is returned to the content provider 8 in a response message 54. Upon receipt of the response message 54, the content provider 8 generates an authentication request message 56, which is then forwarded to the authentication server 14. In the illustrated embodiment, the authentication request message 56 contains information identifying the requesting party 2 and the content that was requested, as well as the telephone number provided by the requesting party 2. This information is used by the authentication server 14 to verify the identity of the requesting party 2 and their right to receive the requested content. Thus in the illustrated embodiment, the authentication server 14 uses the requesting party's telephone number to query a database 30 (at 58), which returns a response message 60 containing information identifying a domain or geographical location telephone 10. This information can be used, in conjunction with the information identifying the requesting party 2 and the requested content, to determine (at 62) whether the requesting party 2 is authorized to receive the requested content (or equivalently, whether the content provider 8 is authorized to distribute the requested content to the requesting party 2). Further authentication and verification may be performed to validate the identity of the requesting party 2, in a manner known in the art. In the illustrated example, it is assumed that the authentication server 14 determines (at 62) that the requesting party 2 is authorized to receive the requested content, and thus an authentication message 64 is formulated by the authentication server 14 and forwarded to the content provider 8.

Upon receipt of the authentication message 64 from the authentication server 14, the content provider 8 generates (at 66) a transaction indicia as a unique identifier associated with the requesting party's request for the identified content. The content provider 8 may also generate (at 68) a serial number in order to coordinate transfer of the transaction indicia to the requesting party 2 through the PSTN 12, as will be explained below.

In order to transfer the transaction indicia to the requesting party 2, a telephone connection is set up through the PSTN 12 to the requesting party's telephone 10. Thus a “call” message 70 containing a Directory Number (DN) of an Interactive Voice Unit (IVR), for example, as well as the serial number, is formulated by the content provider 8 and forwarded through the communications network 6 to the call control node 26. As explained above, the call control node 26 functions as a Virtual Service Switching Point (VSP) within an E-ISUP group 24 of the PSTN 12 and can launch calls from within the PSTN 12. In response to the call message 70, the call control node 26 formulates an Integrated Services Digital Network User Part (ISUP) signaling message to set up a call connection between SSP 20 of the E-ISUP group 24 and the IVR server 28. Thus an ISUP Initial Address Message (ISUP-IAM) 72 is forwarded by the call control node 26 to the SSP 20, which propagates the ISUP-IAM through the PSTN 12 to an SSP 32 that supports an ISDN Primary Rate Interface (PRI) trunk, for example, connected to the IVR 28 (at 74). On receipt of the ISUP-IAM at the SSP 32, the SSP 32 sends an ISDN setup message 75 to the IVR 28, which responds with an ISDN acknowledge message 76. The SSP 32 responds by formulating an ISUP Address Complete Message (ACM) 77 which is propagated back through the PSTN 12 to the SSP 20, and forwarded (at 78) to the call control node 26. Subsequently, the IVR 28 sends an ISDN ANSWER message 79 to the SSP 32, which prompts the SSP 32 to formulate an ISUP Answer Message (ISUP-ANM) 80 that is propagated to the SSP 20, and forwarded (at 82) to the call control node 26. Following receipt of the ISUP-ANM message, the call control node 26 reports (at 83) to the content provider server 8 that the call is complete. The serial number passed to the call control node was, for example, passed to the IVR using the origination number fields of the ISUP-IAM and ISDN setup messages in order to associate the call connection with the current session (that is, the request for content originated by the requesting party 2).

As shown in FIG. 2b, on receipt of the call complete message 83, the content provider server 8 instructs (at 84) the call control node 26 to set up a call connection between the E-ISUP group 24 and the requesting party's telephone. Thus an ISUP-IAM message 86 is formulated by the call control node 26 and forwarded to SSP 18 of the E-ISUP group, which then propagates the ISUP-IAM message (at 88) through the PSTN (12) to the SSP 16 that serves the requesting party's telephone 10. At this point, an ISUP-ACM message 90 and 91 are propagated back from the host SSP 16 to the call control node 26 via the SSP 18 of the E-ISUP group 24. When the requesting party's telephone 10 is taken off hook (at 92), an ISUP-ANM 94 is propagated by the SSP 16 to the call control node 26 via the SSP 18 of the E-ISUP group 24 (at 96). On receipt of the ISUP-IAM, the call control node 26 advises (at 97) the content provider server 8 that the second call is complete.

Subsequently, a play announcement message 98 (FIG. 2b), containing the transaction indicia and the serial number, is forwarded to the IVR server 28 by the content provider server 8. Upon receipt of the play announcement message 96, the IVR server 28 plays an announcement 99 to convey the transaction indicia to the requesting party 2. Upon receiving the transaction indicia from the IVR 28, the requesting party 2 hangs up their telephone (at 100), which causes the telephone connection between the requesting party's telephone 10 and the IVR 28 to be released, using conventional ISUP signaling (at 102) between the SSP 16 serving the receiving party's telephone 10 and the call control node 26, and between the call control node 26 and the IVR 28.

The requesting party 2 generates and forwards a message 104 containing the transaction indicia to the content provider server 8. This may be facilitated by way of a suitable data input window (not shown) displayed on the data communication device 4 in a manner well known in the art.

Although the example described above shows that the transaction indicia is received by the requesting party through the parallel network, it should be understood that the transaction indicia could be sent through either one of the communications network and the parallel network. If the transaction indicia is sent through the communications network and returned through the parallel network, the transaction indicia is preferably not sent through the communications network until the connection through the parallel network is established. The requesting party may then input the transaction indicia using the dial pad, for example, of a telephone through which a connection through the parallel network is established. If the transaction indicia is returned through the parallel network, a dual-tone multi-frequency (DTMF) receiver can be used at the IVR 28 to collect the transaction indicia, which is then passed to the content provider 8. The content provider 8 does not begin content delivery until the transaction indicia is returned by the requesting party 2.

Upon receipt of the message 104 containing the transaction indicia, the content provider server 8 delivers (at 106) the requested content to the requesting party 2. As mentioned previously, and illustrated in FIG. 2b, this step may involve conveying the content through the communications network 6 to the data communications device 4 of the requesting party 2. However, other means of delivering the content may also be used, such as, for example, forwarding a URL or other network address to the requesting party's data communications device 4 in order to enable the data communications device 4 to establish a communications link with a site on the communications network 6 at which the requested content is stored or being multicast to others.

If the content is delivered to the requesting party's data communications device 4, it may be desirable to encrypt the content in order to ensure secure transfer and/or exclusive use by the requesting party. In general, any suitable encryption algorithm may be used for this purpose. However, conventional encryption algorithms typically require that the requesting party 2 provide a password or encryption key in advance, so that the security of the encrypted content is dependent upon the secrecy of the key or password. As mentioned previously, this situation is unsatisfactory because such keys can be appropriated by unauthorized persons. Accordingly, the present invention provides a method of securely distributing the content to the requesting party without requiring the requesting party to provide a password or key.

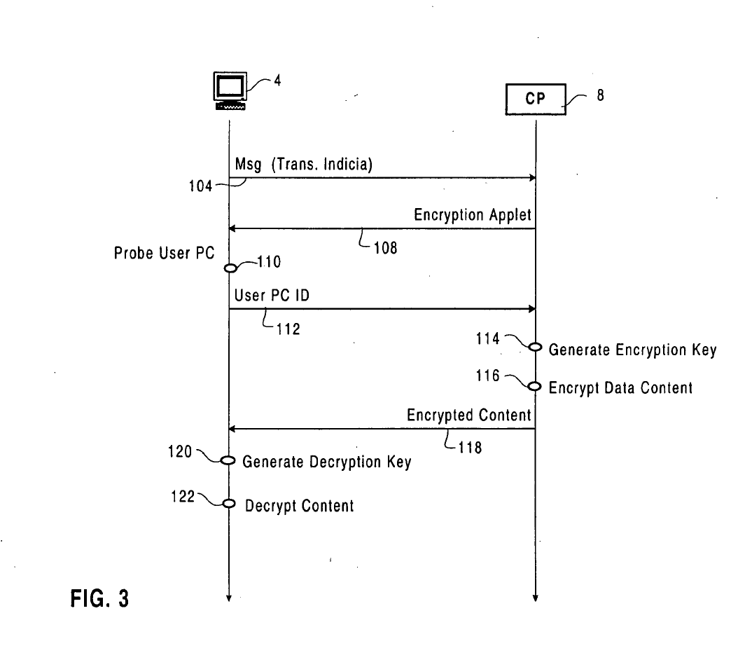

As shown in FIG. 3, upon receipt of the message 104 containing the transaction indicia from the requesting party's data communications device 4, the content provider 8 forwards an encryption script (at 108) through the communications network 6 to the data communications device A. In some embodiments, this encryption script may be selected from a library containing a plurality of different encryption scripts, each of which implements a different encryption algorithm. This decreases the possibility of unauthorized use of the encryption script to gain illicit access to other content.

Upon activation of the encryption script within the requesting party's data communications device 4, the encryption script probes the data communications device 4 (at 110) for one or more parameters that uniquely identify the' data communications device 4. An example of such a parameter is the Media Access Control (MAC) address of the data communications device 4. The encryption script then forwards (at 112) this parameter to the content provider 8, which then uses the parameter to generate an encryption key (at 114) that is unique to the requesting party's data communications device 4. The encryption key is used by the content provider server 8 to encrypt the content (at 116), and the encrypted content is forwarded (at 118) through the communications network 6 to the requesting party's data communications device 4. The encryption script also generates a decryption key (at 120) using the same parameter used by the content provider 8 to generate the encryption key. The decryption key is used by the encryption script to decrypt the content (at 122) for use by the requesting party 2. Since both the encryption and decryption keys are independently generated (by the content provider 8 and the encryption script in the requesting party's data communications device 4, respectively), and since both keys are generated using a parameter unique to the requesting party's data communications device 4, the encrypted content can only be decrypted using the specific data communications device 4 used by the requesting party 2 to request and obtain access to the content. Security can be further enhanced by ensuring that the decryption script will only execute if the parameter used to generate the decryption key matches the corresponding parameter of the data communications device 4 on which the script is run. Thus, unauthorized access and/or duplication of the content is extremely difficult.

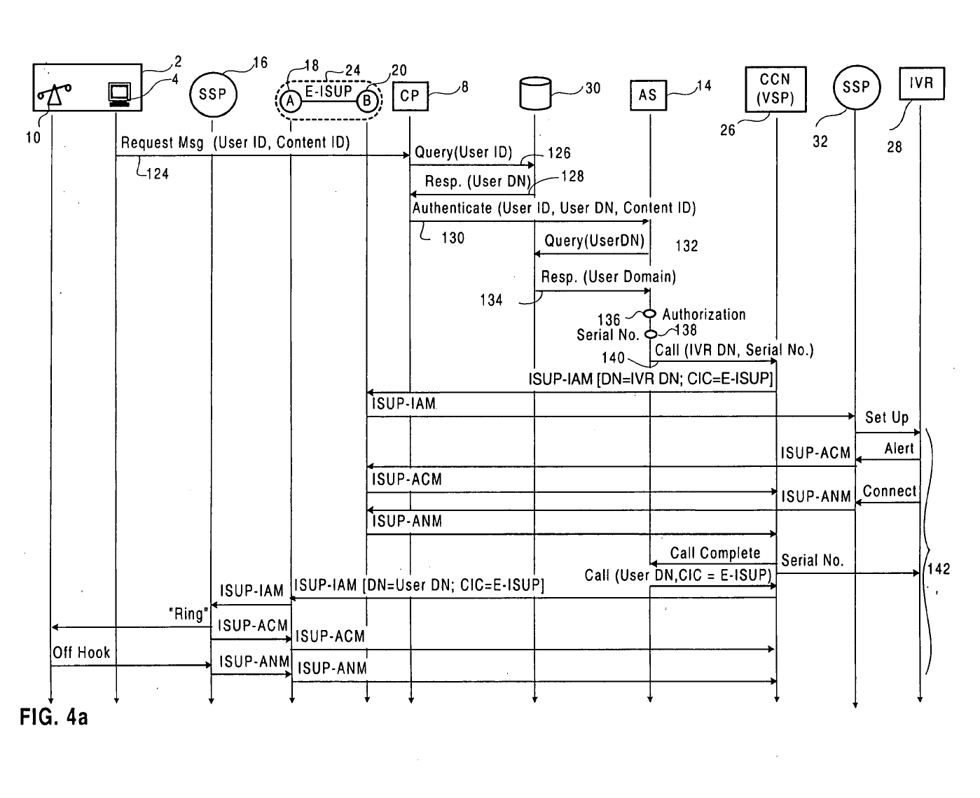

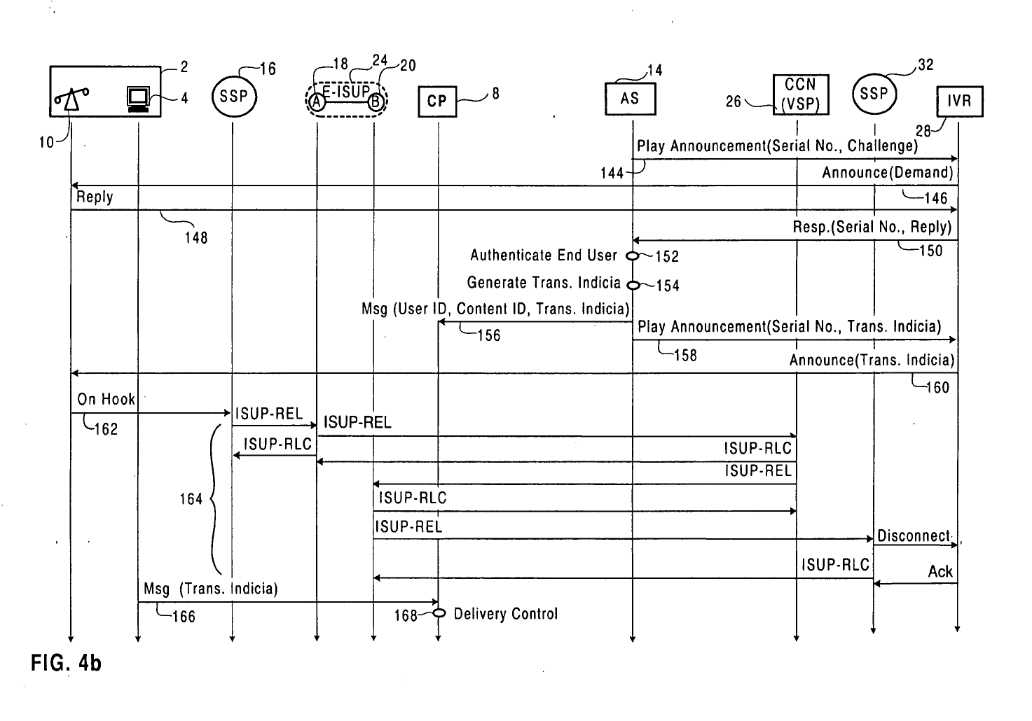

FIGS. 4a and 4b illustrate principle messages exchanged between system elements used for content delivery in accordance with the invention. In the example shown in FIGS. 4a and 4b, the bi-directional communications capability of the IVR 28 is exploited to facilitate enhanced functionality of the authorization server 14, as well as to convey the transaction indicia to the requesting party 2. Furthermore, the example shown in FIG. 4 includes a database 30 containing telephone numbers of previously registered users or subscribers of the content provider. The database 30 is used to obtain the telephone number of the requesting party 2 without having to prompt the requesting party 2 to enter their telephone number. For authorized requesting parties, this feature increases convenience by removing a step in the process of obtaining access to the content. For unauthorized persons, this feature increases the difficulty of successfully obtaining unauthorized delivery of content, because the system forwards the transaction indicia to the requesting party at the registered telephone number, which will likely not be the telephone number of a telephone to which the unauthorized person has access.

As shown in FIG. 4a, the requesting party 2 formulates a request message 124 in the manner described above with reference to FIG. 2, and forwards the request message to the content provider server 8. Upon receipt of the request message, the content provider server 8 uses the information identifying the requesting party 2 to query the database 30 (at 126), and thereby obtain (at 128) a previously registered telephone number of the requesting party 2. The content provider 8 then forwards an authentication request message 130 containing the information identifying the requesting party 2 and the content, along with the requesting party's telephone number, to the authentication server 14. As described above with reference to FIG. 2, the authentication server 14 uses the requesting party's telephone number (at 132) to query a database (which may be the same as, or different from, the database that stores registered telephone numbers) to obtain (at 134) information identifying a domain in which the requesting party 2 is located. The authentication server 14 uses the domain information to determine (at 136) whether distribution of the requested content to the requesting party is authorized. In contrast to the example shown in FIG. 2, this authorization step 136 typically does not include verification of the requesting party's identity, which will be completed at a later stage, as described below.

Upon successful completion of the authorization step 136 above, the authentication server 14 generates a serial number (at 138) associated with this session, and launches a call message 140 containing the directory number (DN) of the IVR 28 and the serial number to the call control node 26. Upon receipt of the call message 140, the call control node 26 functions (at 142) as described above with reference to FIG. 2a, to set up a call connection between the IVR 28 and the requesting party's telephone 10 (that is, the telephone 10 associated with the previously registered telephone number obtained by querying (at 126) the database 30).

As shown in FIG. 4b, once the call connection has been set up between the IVR 28 and the requesting party's telephone 10, a play-announcement message 144 is forwarded by the authentication server 14 to the IVR server 28. In response to the play-announcement message 144, the IVR 28 plays a “demand” message (at 146) to the requesting party 2 in which the requesting party 2 is notified of the request for content, and invited to input an indication of whether they wish to proceed. The indication may take the form of dialed digits input by the requesting party 2 using their telephone 10, or by a verbal response such as “YES” or “NO”. In either event, the reply provided by the requesting party 2 (at 148) is processed by the IVR 28 which formulates a response message 150 to the authentication server 14.

Following receipt of the response message 150 from the IVR 28, the authentication server 14 may optionally further authenticate the requesting party 2 (at 152). Further authentication may include verification of the identity of the requesting party 2. If a verbal response was obtained from the requesting party 2, the response message 150 received by the authentication server 14 may include a recording (or a digitally processed version) of the requesting party's verbal input. This may be used by the authentication server 14 to perform a voice-print analysis in a manner known in the art, and thereby validate the identity of the requesting party 2.

Following successful authentication of the requesting party 2, a transaction indicia uniquely associated with the requesting party's request for access to the content is generated (at 154) and forwarded to the content provider server 8 (at 156). Alternatively, an authentication result message may be forwarded by the authentication server 14 to the content provider server 8, which then generates the transaction indicia, as described above in the embodiment of FIG. 2. In either case, a play-announcement message 158 containing the transaction indicia is then forwarded to the IVR server 28, which then announces (at 160) the transaction indicia to the requesting party 2 as described above with reference to FIG. 2.

Following receipt of the transaction indicia, the requesting party 2 places their telephone on-hook (at 162), which causes release of the call connection between the requesting party's telephone 10 and the IVR 28 (at 164). Subsequently, the requesting party 2 formulates and sends a message 166 containing the transaction indicia to the content provider 8 which thereafter provides access (at 168) to the content as described above with reference to FIGS. 2 and 3.

Although the examples described above illustrate use of the PSTN as the parallel network through which the transaction indicia is deliver to an ordinary telephone set, it is contemplated that the transaction indicia my be sent to a facsimile machine, or an Analogue Services Display Interface (ADSI) telephone, as described above. It is also possible to automate the return of the transaction indicia if customer premise equipment such as an ADSI telephone is used to deliver the transaction indicia. It should also be understood that the parallel network need not be a switched telephone network. The parallel network may be any one of: an asynchronous transfer mode (ATM) network, and a Frame Relay network, for just two of many other examples.

The embodiment(s) of the invention described above is (are) intended to be exemplary only. The scope of the invention is therefore intended to be limited solely by the scope of the appended claims.

1-27. (canceled)

28. A method of controlling distribution of content through a first communications network, the method comprising:
receiving a request message for the content, the request message sent by a party through the first communications network, the request message including information identifying the party;
formulating a transaction indicia uniquely associated with the request message;
entering into communication with the party via a connection established through a second communications network;
conveying the transaction indicia to the party through one of the first and second communications networks by announcing the transaction indicia to the party, said conveying the transaction indicia being performed after said entering into communication with the party via the connection established through the second communications network; and
receiving a validation message containing the transaction indicia, the validation message returned by the party through the other of the first and second communications networks.

29. The method defined in claim 28, wherein said second communications network includes a telephone network and wherein said connection established through the second communications network is a voice communications link.

30. The method defined in claim 29, wherein said announcing the transaction indicia to the party comprises playing a voice message conveying the transaction indicia.

31. The method defined in claim 29, wherein said one of the first and second communications networks is the second communications network and wherein said other of the first and second communications networks is the first communications network.

32. The method defined in claim 31, wherein said first communications network includes a data network.

33. The method defined in claim 32, wherein said entering into communication with the party includes placing a telephone call to the party.

34. The method defined in claim 33, wherein said announcing the transaction indicia to the party is effected via the connection established through the second communications network.

35. The method defined in claim 28, wherein said one of the first and second communications networks is the first communications network and wherein said other of the first and second communications networks is the second communications network.

36. The method defined in claim 35, wherein said first communications network includes a data network and wherein said second communications network includes a telephone network.

37. The method defined in claim 36, wherein the connection established through the second communications network is a telephone connection.

38. The method defined in claim 37, wherein said entering into communication with the party includes answering a telephone call placed by the party.

39. The method defined in claim 38, wherein said announcing the transaction indicia to the party is achieved by transmission of a digital electronic message to the party.

40. The method defined in claim 29, wherein the transaction indicia is used for validating only one request for content.

41. The method defined in claim 29, wherein the transaction indicia has a limited time to live and the content is not delivered unless the validation message is received before the time to live has expired.

42. The method defined in claim 29, wherein the formulating a transaction indicia comprises authenticating a right of the party to receive the content.

43. The method defined in claim 42, wherein the authenticating a right of the party to receive the content comprises using a telephone number to determine whether the party is located within a predetermined domain.

44. The method defined in claim 43, wherein the predetermined domain comprises at least one of:
a predetermined geographical region;
a service area of a network service provider;
a company employee; and
an Internet domain.

45. The method defined in claim 43, wherein the determining whether the party is located within a predetermined domain comprises using information identifying the party to query a database that stores domain information related to the party.

46. The method defined in claim 29, wherein the connection is established using the information identifying the party.

47. The method defined in claim 46, wherein said entering into communication with the party comprises determining an address of the party on the telephone network.

48. The method defined in claim 47, wherein said determining an address of the party on the telephone network comprises using the information identifying the party to query a database that stores address information associated with a device on the telephone network.

49. The method defined in claim 46, wherein said entering into communication with the party comprises setting up a call connection between an interactive voice response (IVR) unit and a telephone set associated with the party.

50. The method defined in claim 29, further comprising:
receiving information uniquely identifying a content delivery device associated with the party;
generating an encryption key using the information uniquely identifying the content delivery device;
encrypting the content using the encryption key; and
forwarding the encrypted content to the content delivery device associated with the party through at least one of the first and second communications networks.

51. The method defined in claim 50, wherein the information uniquely identifying the content delivery device associated with the party comprises a media access control (MAC) address of the content delivery device.

52. A system for controlling distribution of content through a first communications network, the system comprising:
means for formulating a transaction indicia uniquely associated with a request message received through the first communications network from a party requesting content delivery;
means for conveying the transaction indicia to the party through one of the first and a second communications networks with customer premise equipment associated with the party by announcing the transaction indicia to the party after entering into communication with the party via a connection established through the second communications network; and
means for enabling the party to return the transaction indicia through the other of the first and second communications networks to initiate delivery of the content.

53. The system defined in claim 52, wherein said second communications network includes a telephone network and wherein said connection established through the second communications network is a voice communications link.

54. The system defined in claim 53, wherein said means for conveying comprises an interactive voice response (IVR) unit.

55. A method of controlling distribution of content through a communications network, the method comprising:
receiving a request message of the content sent by a party through the communications network, the request message including information identifying the party;
authenticating the right of the party to receive the content by determining whether the party is located within a predetermined domain using the information identifying the party;
formulating a transaction indicia uniquely associated with the request message if the right of the party to receive the content is authenticated;
conveying the transaction indicia to the party through one of a parallel network and the communications network using the information identifying the party; and
receiving a validation message containing the transaction indicia returned by the party through the other of the communications network and the parallel network.

56. A method defined in claim 55, wherein the predetermined domain comprises at least one of:
a predetermined geographical region;
a service area of a network service provider;
a company employee; and
an Internet domain.

57. A method defined in claim 55, wherein authenticating the right of the party to receive the content comprises determining if a telephone number associated with the party indicated by the information identifying the party is grouped within the predetermined domain.

58. A method defined in claim 57, wherein the determining if a telephone number associated with the party is grouped within the predetermined domain comprises querying a database that stores domain information related to the party using the telephone number associated with the party.

59. A method defined in claim 55, wherein the transaction indicia is used for validating only one request for content.

60. A method defined in claim 55, wherein the information identifying the party comprises at least one of:
an address of the party on the parallel network;
a User ID; and
a user password.

61. A system for controlling distribution of content through a communications network, the system comprising:
a. means for authenticating a right of a party to receive content upon receipt of a request message received through the communications network from a party requesting content delivery, the means for authenticating comprising means for determining whether the party is located within a predetermined domain using a telephone number associated with the party indicated within the request message;
b. means for formulating a transaction indicia uniquely associated with the request message if the right of the party to receive the content is authenticated;
c. means for conveying the transaction indicia to the party through one of the communications network and a parallel network; and
d. means for enabling the party to return the transaction indicia through the other of the communications network and the parallel network and the parallel network to initiate delivery of the content.

62. A system defined in claim 61, wherein the parallel network comprises any one of a telephone network, a frame relay network, and, an asynchronous transfer mode (ATM) network.

63. A system defined in claim 61, wherein the customer premise equipment is programmed to automatically return the transaction indicia through the communications network.
